(19) United States
(12) Patent Application Publication
(10) Pub. No.: US 2010/0097034 A1
(43) Pub. Date: Apr. 22, 2010

(54) HIERARCHICAL BATTERY MANAGEMENT SYSTEM

(75) Inventors: Ying-How Shu, Taipei City (TW); Feng-Yuan Wang, Taipei City (TW); Ching-Chuan Lee, Taipei City (TW); Peng-Ming MA, Taipei City (TW)

Correspondence Address: SCHMEISER OLSEN & WATTS, 18 E UNIVERSITY DRIVE, SUITE # 101, MESA, AZ, 85201, US

(73) Assignee: All New Energy Technology Corp., Taipei City (TW)

(21) Appl. No.: 12/253,817

(22) Filed: Oct. 17, 2008

(51) Int. Cl. H02J 7/04

(52) U.S. Cl. 320/126

(57) ABSTRACT

A hierarchical battery-management system mainly comprises a monitoring and equalizing module, an intermediary module and a communication and decision module. The monitoring and equalizing module electrically couples with the battery. The intermediary module electrically couples with the monitoring and equalizing module and the communication and decision module; besides, the communication and decision module electrically couples with a power system or an electronic/electrical apparatus. The present invention uses a digital transmission interface constructed from an uplink/downlink circuit with a DC isolation component for common battery management, and a hierarchical management structure constructed by the intermediary module to screen data and to transmit meaningful cell data to meet real time managing requirements of the large battery set.

### BACKGROUND OF THE INVENTION

1. Field of the Invention

The present invention relates to a hierarchical battery-management system, and more particularly to a hierarchical battery-management system which consists of a monitoring and equalizing module, an intermediary module, and a communication and decision module. The monitoring and equalizing module is coupled to battery packs. The intermediary module is used to link and communicate between the monitoring and equalizing module and communication and decision module, and to extract meaningful cell data from the monitoring and equalizing module for the communication and decision module. And the communication and decision module is coupled, and communicates with the electrical/electronic apparatus, therefore the electrical/electronic apparatus with this hierarchical battery-management system is able to get cell information in real-time. The digital communication interface used in this invention constructs from the uplink/downlink circuits with DC isolation components.

2. Description of the Prior Art

Presently electric vehicles use digital interface to control the charging/discharging operation of the power system and to monitor the residual capacity of the battery and other operating conditions. As technology evolves, the battery capacity and the battery power gradually improve, in order to achieve best battery performance; it has become a sure trend for battery sets to cascade or to connect in parallel. Therefore, it is now necessary for a digital monitoring system of the electric vehicle to maintain and to replace these battery sets cascaded or connected in parallel.

Most of the electronic/electrical apparatuses using battery as main power system or backup system have adopted digital interfaces to monitor the status of battery. Through a digital interface, the electronic/electrical apparatus can estimate the residual capacity of the battery and issue a warning when the battery doesn't function normally. Lead-acid batteries are more popular in large battery sets than lithium based batteries, because the latter might explode and burn when used in a large battery set. In addition, lead-acid batteries provide advantages such as low costs and easy maintenance. In a system using lead-acid batteries, since the lead-acid battery has high tolerance towards over voltage and low voltage conditions, and it can deal with slightly over-charged problem by electrolysis and heat dissipation, the battery monitoring system of lead-acid batteries focuses on monitoring the battery capacity other than issues such as battery voltage balance or voltage monitoring for a single battery. The battery monitoring system tends to be simple and uses only simple digital transmission interface to communicate with the electronic/electrical apparatus. As the development trends going towards electrical vehicles and LiFePO₄ batteries, now the battery monitoring system has to monitor much more than the battery capacity. The battery weight is an important factor for energy efficiency of the electric vehicle; therefore it is necessary to reduce the battery weight to increase the loading capacity and to improve battery sustainability. The LiFePO₄ battery or the improved Li—Mn battery can now meet the safety and working temperature requirements of electric vehicles or large power system; however, Li based batteries still have over voltage/low voltage problems due to their low internal resistance and high charging efficiency to ensure the use thereof. For large power system, it is necessary to use tens to thousands of battery cells to cascade or to connect in parallel to achieve the required capacity and operating voltage. Such battery set is implemented using a plurality of battery packs to facilitate voltage monitoring of modules, even each single battery. Traditional battery protecting module, due to less number of battery cells, uses traditional industrial transmission interface (such as IEEE485/IEEE488), or local interconnect network (CAN 2.0B) to monitor and communicate with the battery packs.

Please refer to FIG. 1 for a cascading structure of digital transmission interface. The cascading structure comprises an isolating circuit to deal with different operating voltages and a cascading digital interface to facilitate module management and maintenance. For example, if there are 108 battery sets to monitor, under a fast transmission mode, it still takes 1.53 seconds to transmit the status data of the battery (In this figure, the transmission rate is 19,200 bps, and every 8 bit data needs a transmission time of 11 bits, the downlink command comprises four 8-bits, and the maximum response delay time of the monitoring and equalizing module is 5 ms, so the communication time for the battery system is (11*4+12)/19200+0.005)*108=1.53 second), which raises the reliability concern for the operation of real time monitoring of the electric vehicle or large backup power system (UPS).

In prior art digital transmission techniques related to battery management, whether the transmission interface uses a network connection configuration, or a one-wire star connection configuration (One-Wire, Maxim/HDQ Bus, Ti), or double-wire configuration (Smart Management Bus, Intel/CAN-Bus, Controller Area Network), a single battery management module is often used to make decisions, or the battery packs communicates with each other through an interconnect network to make decisions on their own.

From the above descriptions, the traditional battery management systems tend to have the following problems:
1. Large battery set has safety concern due to its high voltage and large capacity. Furthermore, the costs and weight of a large battery set are the reasons why it has to be segmented to reduce the maintenance costs.
2. Large battery set uses a lot of battery cells and has a safety limit for the number of batteries connecting in parallel; also, there are more battery packs to monitor simultaneously. As the capacity of battery increases, more monitoring modules are required and more monitoring data are generated, more data requires more resource from the transmission interface and then increases the delay time for the battery monitoring system to obtain data from each battery; besides, each battery data may have different reference point of time.
3. Furthermore, the operating voltages of protection boards of battery sets are different, the difference between operating voltages may be 300 to 500 volts, under this circumstance, the traditional controller-area network (CAN-bus) or star network is not available for such a high voltage.
4. The center controller of the controller-area network (CAN-bus) or star network must monitor many components other than batteries, there might be delay or network configuration problems for connecting all battery packs in parallel; on the other hand, while cascading and isolating the battery packs solves the problem of different reference voltages between battery packs and requires less identification numbers (ID), the large data generated by simultaneously monitoring all battery packs still causes delay and low decision making process.
5. Due to increasing demand of electricity, the number of battery packs connecting to power network in cascading configuration or in parallel greatly increases, which means the amount of data will increase as well, therefore, the transmitted data amount on the interconnect network explodes and causes more delay during the transmission; delay in data transmission could lead to untimely decision and affect the decision result.

Therefore, the traditional battery management systems present several shortcomings to be overcome.

In view of the above-described deficiencies of the traditional battery management system, after years of constant effort in research, the inventor of this invention has consequently developed and proposed a hierarchical battery-management system in the present invention

### SUMMARY OF THE INVENTION

It is an object of the present invention to provide a hierarchical battery-management system which uses an intermediary module to screen and transmit meaningful cell data to meet real time managing requirements of large battery set.

It is an object of the present invention to provide a hierarchical battery-management system which can effectively reduce the amount of data required for managing batteries to speed up the decision process and to cut down the time required for the power system controller to obtain the status information of the battery set so as to meet real-time monitoring requirements of the power system.

In order to achieve the above objects, the present invention discloses a hierarchical battery-management system, which comprises a monitoring and equalizing module, an intermediary module and a communication and decision module. Due to maintenance and operation requirements of large power system, the large battery set is segmented into a plurality of battery packs; therefore, it would be easier to manage the plurality of battery sets if the battery management system is constructed in a hierarchical structure. Then the data required for battery monitoring can be processed and screened in advance. The amount of the screened data is greatly reduced, and the decision time is shortened through parallel processing of each segmented battery pack.

The present invention uses a digital transmission interface constructed from an uplink/downlink circuit with a DC isolation component for common battery management and for segmenting a large battery set into a number, or tens of battery packs (sub-pack), and a hierarchical management structure constructed by the intermediary module to screen data and to transmit meaningful cell data to meet real time managing requirements of large battery set.

### BRIEF DESCRIPTION OF THE DRAWINGS

FIG. 1 illustrates a traditional cascading structure of a digital transmission interface;

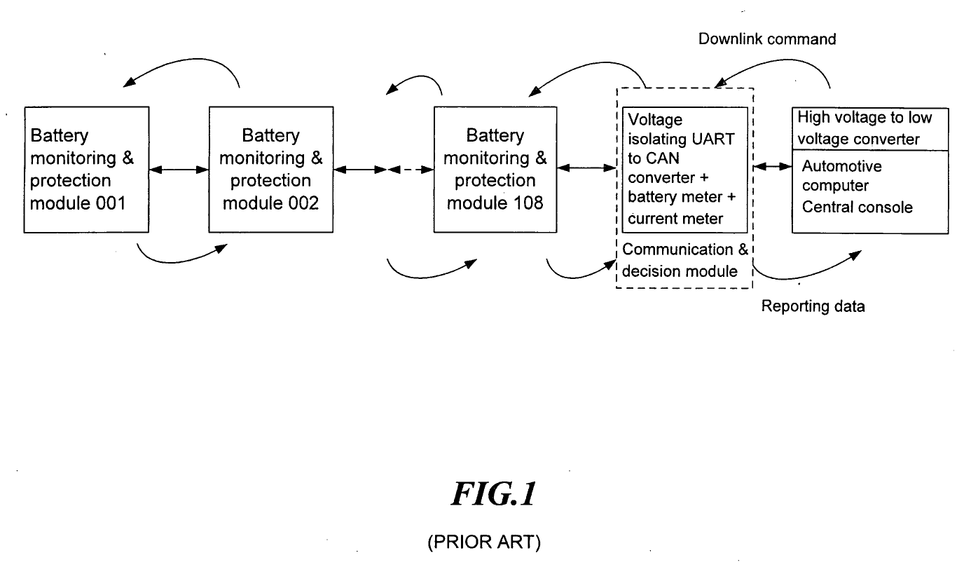

FIG. 2 illustrates a segmented battery pack structure of a hierarchical battery-management system in the present invention;

FIG. 3 illustrates a first embodiment of the hierarchical battery-management system; and

FIG. 4 illustrates a second embodiment of the hierarchical battery-management system.

### REFERENCE NUMERALS

Segmented battery pack 2
communication and decision module 3
high voltage to low voltage converter 4
Segmented battery pack 5
communication and decision module 6
high voltage to low voltage converter 7
monitoring and equalizing module 11
intermediary module 12

### DETAILED DESCRIPTION OF THE PREFERRED EMBODIMENT

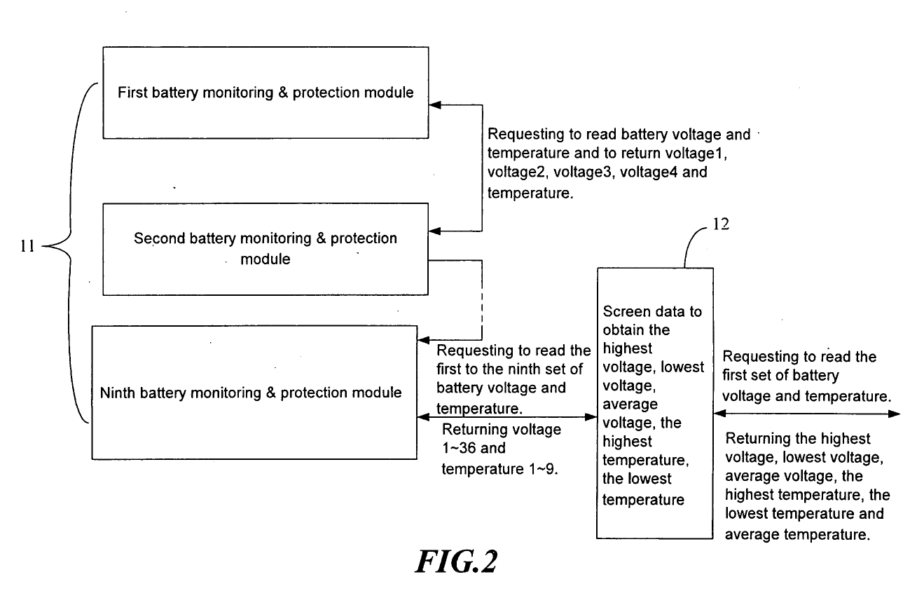

Please refer to FIG. 2, which illustrates a segmented battery pack structure of a hierarchical battery-management system in the present invention, the hierarchical structure comprises:

Nine monitoring and equalizing modules 11, the nine monitoring and equalizing modules 11 couple with a intermediary module 12 and directly connect with the battery; besides, each monitoring and equalizing module cascades to one another for reading the battery voltage and battery temperature of each battery cell requested by the intermediary module 12, and each monitoring and equalizing module will transmit four sets of voltage data and one set of temperature data to the intermediary module 12. When the intermediary module 12 requests to read the battery voltage and battery temperature provided by the nine monitoring and equalizing modules 11, the total amount of requesting data is (9*2)*2 Bytes=36 Bytes, while the amount of 36 sets of voltage data and 9 sets of temperature data transmitted by the nine monitoring and equalizing module 11 is (36+9)*2 Bytes=90 Bytes.

The intermediary module 12 couples with the nine monitoring and equalizing module 11 to read each monitoring and equalizing module at specific time in advance for recording the voltage of each battery cell and temperature value of the monitoring point, and also screens effective data related to monitoring and equalizing modules at the same time for the communication and decision module. In one embodiment of the present invention, the requested data comprises the highest, lowest, and average voltage, and the highest, lowest, and average temperature.

Traditionally, the prior art battery management system has to call each monitoring and equalizing module sequentially and receives the battery voltage and battery temperature values at multi monitoring points of each battery cell transmitted by the monitoring and equalizing module. For example, for a large battery set having 36 battery cells, the amount of voltage data transmitted is 36*2 Bytes=72 Bytes, while the temperature data is 18 Bytes. If the hierarchical structure is deployed, the reading instruction sent by the communication and decision module is only 4 Bytes, while the intermediary module 12 only needs to return 12 Bytes of data.

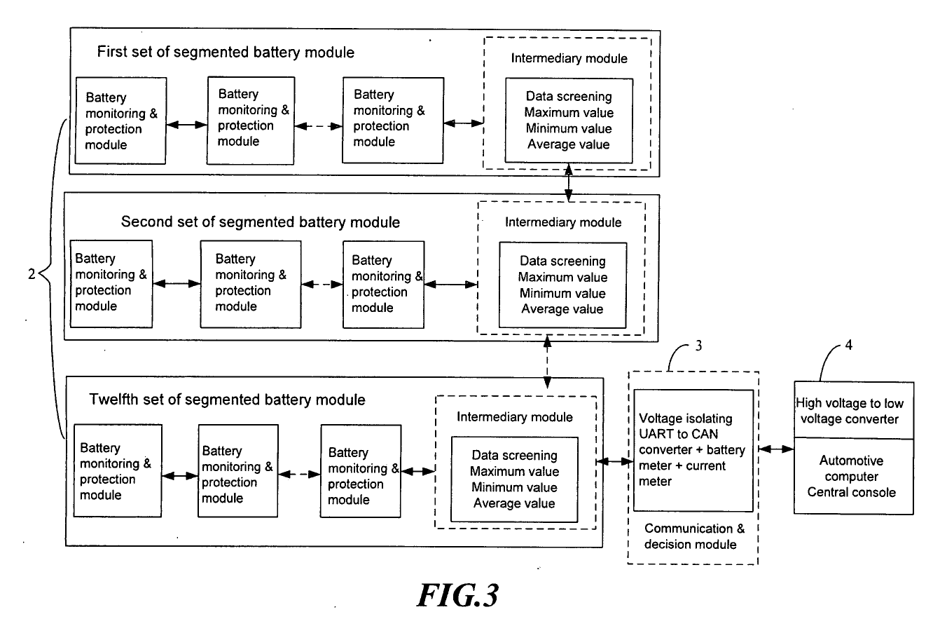

Please refer to FIG. 3, which illustrates a first embodiment of the hierarchical battery-management system, the hierarchical structure for managing the battery packs (in cascading configuration) comprises twelve sets of segmented battery packs 2 and the communication and decision module 3.

The first set of the twelve sets of segmented battery packs 2 couples with the second set thereof, and so on (that is the first couples with the second, the second with the third, the third with the fourth, etc), and the twelfth set of segmented battery packs 2 couples with the communication and decision module 3. The twelve sets of segmented battery packs are coupled with one another sequentially, with nine monitoring and equalizing modules and an intermediary module in each one of the segmented battery pack. Battery monitoring data is processed and screened by the internal intermediary module in advance, and then is transmitted the communication and decision module 3 through the digital transmission interface between battery sub-packs. Digital signals representing high and low battery voltage can be transmitted to the communication and decision module 3 through the common digital transmission interface.

The communication and decision module 3 couples with the twelfth set of segmented battery packs and a high voltage to low voltage converter 4. The high voltage to low voltage converter 4 provides power to the communication and decision module 3. The communication and decision module 3 determines an operation instruction or a parameter to keep the battery voltage balance. The instruction is transmitted through the intermediary modules of the twelve sets of segmented battery packs 2 to each monitoring and equalizing module; besides, the communication and decision module 3 can connect to the power system or the electrical/electronic apparatus.

This fast and effect battery management system greatly reduces the transmission time of digital data and shortens the response time for the monitoring and equalizing module; furthermore, this hierarchical battery-management system is applicable to more layers for battery management to keep the response time of the monitoring and equalizing module as low as possible without being affected by the increasing capacity of the battery set.

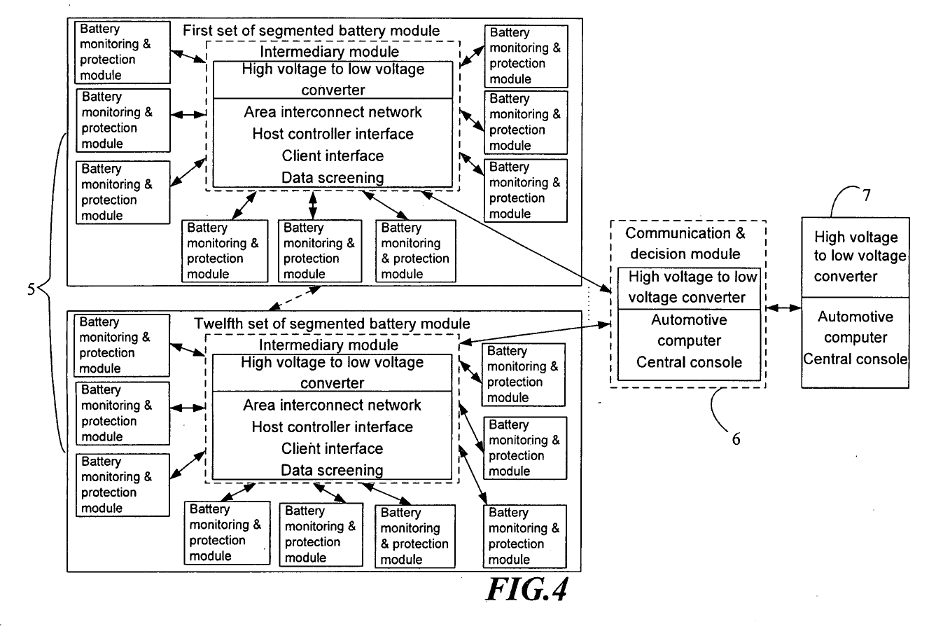

Please refer to FIG. 4, which illustrates a second embodiment of the hierarchical battery-management system, the hierarchical structure for managing the battery packs (connected in parallel configuration) comprises twelve sets of segmented battery packs 5 and the communication and decision module 6.

Each one of the twelve sets of segmented battery packs 5 couples with the communication and decision module 6, with nine monitoring and equalizing modules and an intermediary module in each one of the segmented battery pack. The nine monitoring and equalizing modules couples with the intermediary module respectively. Battery monitoring data is processed and screened by the internal intermediary module in advance to greatly reduce the transmission time of digital data and to improve the response time of the monitoring and equalizing module.

The communication and decision module 6 couples with the twelve sets of segmented battery packs 5 and a high voltage to low voltage converter 7. The communication and decision module 6 connects with each one of the twelve sets of segmented battery packs 5 in parallel respectively. The problem lies with using traditional interconnect network and large battery set is that the parallel interconnect network is too large and complicated to maintain and to cause difficulties in replacing some of the battery packs; meanwhile, the present invention provides segmented battery packs and introduces the hierarchical battery-management system, thus keeping the number of interconnect network connections for battery management under an acceptable range.

The present invention discloses a hierarchical battery-management system, while compared with other prior art battery management systems, is advantageous in:
1. The present invention discloses a hierarchical battery-management system, which uses intermediary modules to screen and transmit meaningful cell data to meet requirements of the power system for real-time monitoring and management of large battery set.
2. The present invention discloses a hierarchical battery-management system, which can easily manage large battery set by introducing a hierarchical management structure to reduce the amount of data required for managing batteries and to shorten the time for the power system controller to obtain the status information of the large battery set.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A hierarchical battery-management system, comprising:
a plurality set of segmented battery packs, the plurality set of segmented battery packs coupling with a communication and decision module, and the plurality set of segmented battery packs comprising a plurality set of monitoring and equalizing modules and intermediary modules; the plurality set of monitoring and equalizing modules coupling with the intermediary module and directly connecting to the battery sub-packs, each monitoring and equalizing module coupling with each other and reading a battery voltage and a temperature of a battery cell respectively in response to the request of the intermediary module; the intermediary module coupling with the plurality set of monitoring and equalizing modules to read the data of each monitoring and equalizing module at a specific time based on requirements;
a communication and decision module, the communication and decision module coupling with the plurality set of segmented battery packs and being provided for determine an operation instruction or a parameter to keep the battery voltage balance.

2. The hierarchical battery-management system of claim 1, wherein the intermediary module processes and screens data, and communicates with the monitoring and equalizing modules and the communication and decision module.

3. The hierarchical battery-management system of claim 1, wherein at least one of the plurality set of monitoring and equalizing modules and the intermediary module comprises a digital transmission interface having a DC isolation component.

4. The hierarchical battery-management system of claim 1, wherein the plurality set of segmented battery packs comprise a hierarchical management structure.

5. The hierarchical battery-management system of claim 4, wherein the hierarchical management structure is a multi-layered structure having two or more layers.

6. The hierarchical battery-management system of claim 1, wherein the communication and decision module connects to a power system or an electrical/electronic apparatus.
